(19) United States
(12) Patent Application Publication
(10) Pub. No.: US 2003/0234532 A1
(43) Pub. Date: Dec. 25, 2003

(54) Miniaturized scoreboard consumer products

(76) Inventor: Hilton Holton, Wrightsville, GA (US)

Correspondence Address: LITTMAN LAW OFFICES, LTD., P.O. BOX 15035 CRYSTAL CITY STATION, ARLINGTON, VA, 22215, US

(21) Appl. No.: 10/178,849

(22) Filed: Jun. 25, 2002

(51) Int. Cl. G09B 19/22

(52) U.S. Cl. 283/48.1

(57) ABSTRACT

Miniaturized scoreboard consumer product methods and products include an item for use as a consumer product, and a miniaturized scoreboard with a predetermined score at a predetermined time of a predetermined sporting event, wherein the miniaturized scoreboard is on a surface of the item. The miniaturized scoreboard consumer product may include a predetermined name of a first participant in the predetermined sporting event, a predetermined name of a second participant in the predetermined sporting event, or any number of additional predetermined names of additional participants in the predetermined sporting event. The miniaturized scoreboard consumer product may include a predetermined name of the predetermined sporting event and/or a predetermined date of said predetermined sporting event.

### BACKGROUND OF THE INVENTION

1. Field of the Invention

The present invention relates generally to collectible or memorabilia articles and, more particularly to miniaturized scoreboard collectible or memorabilia consumer products.

2. Description of the Related Art

Certain types of collectible or memorabilia articles in the field of sports are very familiar to individuals. For example, such articles may include devices, implements, pieces of clothing, photographs, plaques, cards, pennants, mugs, glasses, steins, chalices, baseballs, footballs, hockey pucks, or the like. Such articles are often decorated or otherwise configured to resemble or portray team names, team symbols, statistical information, biographical information, or the like. However, current consumer product is configured to show the actual final score of a sport game or race.

The related art is represented by the following references of interest.

U.S. Design Pat. No. 262,096, issued on Dec. 1, 1981 to Sherman L. Riggsbee, shows an ornamental design for a tennis scoreboard. Riggsbee does not suggest miniaturized scoreboard consumer products according to the claimed invention.

U.S. Design Pat. No. 272,328, issued on Jan. 24, 1984 to Brigitte Breyer, shows an ornamental design for a hanging decoration in the form of a miniature football uniform. Breyer does not suggest miniaturized scoreboard consumer products according to the claimed invention.

U.S. Design Pat. No. 282,151, issued on Jan. 14, 1986 to Helen F. Mills, shows an ornamental design for a neck pendant. Mills does not suggest miniaturized scoreboard consumer products according to the claimed invention.

U.S. Design Pat. No. 300,435, issued on Mar. 28, 1989 to Gregory A. Harris et al., shows an ornamental design for an advertising scoreboard. Harris et al. does not suggest miniaturized scoreboard consumer products according to the claimed invention.

U.S. Design Pat. No. 311,501, issued on Oct. 23, 1990 to Andre Defayette, shows an ornamental design for a card game scoreboard. Defayette does not suggest miniaturized scoreboard consumer products according to the claimed invention.

U.S. Design Pat. No. 388,342, issued on Dec. 30, 1997 to B. Wayne Hughins et al., shows an ornamental design for a combined scoreboard and interchangeable indicia. Hughins et al. does not suggest miniaturized scoreboard consumer products according to the claimed invention.

U.S. Design Pat. No. 402,987, issued on Dec. 22, 1998 to James E. Wicks, shows an ornamental design for a pager pendant. Wicks does not suggest miniaturized scoreboard consumer products according to the claimed invention.

U.S. Pat. No. 2,348,431, issued on May 9, 1944 to Bernard A. Warmey et al., describes a scoring device for use in connection with the game of basketball. Warmey et al. does not suggest miniaturized scoreboard consumer products according to the claimed invention.

U.S. Pat. No. 2,513,623, issued on Jul. 4, 1950 to Lawrence L. Bray, describes a portable scoreboard of a size that is plainly visible form an entire ball playing field to indicate the score in games of sport. Bray does not suggest miniaturized scoreboard consumer products according to the claimed invention.

U.S. Pat. No. 4,751,506, issued on Jun. 14, 1988 to Colin T. Brown, describes a display device for displaying numerical results of athletics and/or games and the like formed from a rear support panel attached to a front cover of colored transparent sheet material by a surrounding frame forming a shallow box. Brown does not suggest miniaturized scoreboard consumer products according to the claimed invention.

U.S. Pat. No. 5,615,636, issued on Apr. 1, 1997 to Carl E. Gustafon, describes a portable scoreboard which breaks down into separate pieces for easy storage and transportation. Gustafson does not suggest miniaturized scoreboard consumer products according to the claimed invention.

Great Britain Patent document 2 289 628 A, published on Nov. 29, 1995, describes a double sided scoreboard. Great britain ‘628 does not suggest miniaturized scoreboard consumer products according to the claimed invention.

None of the above inventions and patents, taken either singularly or in combination, is seen to describe the instant invention as claimed.

### SUMMARY OF THE INVENTION

The present invention are miniaturized scoreboard consumer products. A method for producing a miniaturized scoreboard consumer product includes the steps of supplying an item for use as a consumer product, and providing a miniaturized scoreboard with a predetermined score at a predetermined time of a predetermined sporting event, and applying the miniaturized scoreboard on a surface of the item.

The method of producing a miniaturized scoreboard consumer product may further include providing a predetermined name a first participant in the predetermined sporting event, a predetermined name of a second participant in the predetermined sporting event, and any more predetermined names of additional participants, according to the desires of the user. The method of producing a miniaturized scoreboard consumer product may further include providing a predetermined name to the predetermined sporting event, and/or a predetermined date to said predetermined sporting event. The method of producing a miniaturized scoreboard consumer product may further include selecting the item as a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, a bottle, or the like.

The miniaturized scoreboard consumer product includes an item for use as a consumer product, and a miniaturized scoreboard with a predetermined score at a predetermined time of a predetermined sporting event, wherein the miniaturized scoreboard is on a surface of the item. The miniaturized scoreboard consumer product may include a predetermined name of a first participant in the predetermined sporting event, a predetermined name of a second participant in the predetermined sporting event, or any number of additional predetermined names of additional participants in the predetermined sporting event.

The miniaturized scoreboard consumer product may include a predetermined name of the predetermined sporting event and/or a predetermined date of said predetermined sporting event. The miniaturized scoreboard consumer product may be an item such as a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, a bottle, or the like.

Accordingly, it is a principal aspect of the invention to provide a method for producing a miniaturized scoreboard consumer product including the steps of supplying an item for use as a consumer product, and providing a miniaturized scoreboard with a predetermined score at a predetermined time of a predetermined sporting event, and applying the miniaturized scoreboard on a surface of the item.

It is another aspect of the invention to provide a method of producing a miniaturized scoreboard consumer product including providing a predetermined name to the predetermined sporting event, and/or a predetermined date to said predetermined sporting event.

It is a further aspect of the invention to provide miniaturized scoreboard consumer products a miniaturized scoreboard consumer product that includes an item for use as a consumer product, and a miniaturized scoreboard with a predetermined score at a predetermined time of a predetermined sporting event, wherein the miniaturized scoreboard is on a surface of the item

Still another aspect of the invention is to provide a miniaturized scoreboard consumer product including a predetermined name for the predetermined sporting event, and/or a predetermined date for the predetermined sporting event.

It is an aspect of the invention to provide improved elements and arrangements thereof in miniaturized scoreboard consumer products for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front, perspective view of one example of a miniaturized scoreboard consumer product according to the present invention.

FIG. 2 is a front, perspective view of one example of a miniaturized scoreboard consumer product according to the present invention

FIG. 3 is a front, perspective view of one example of a miniaturized scoreboard consumer product according to the present invention

Similar reference characters denote corresponding features consistently throughout the attached drawings.

### DETAILED DESCRIPTION OF THE PREFERRED EMBODIMENTS

The present invention is miniaturized scoreboard consumer products. The invention disclosed herein is, of course, susceptible of embodiment in many different forms. Shown in the drawings and described hereinbelow in detail are preferred embodiments of the invention. It is to be understood, however, that the present disclosure is an exemplification of the principles of the invention and does not limit the invention to the illustrated embodiments.

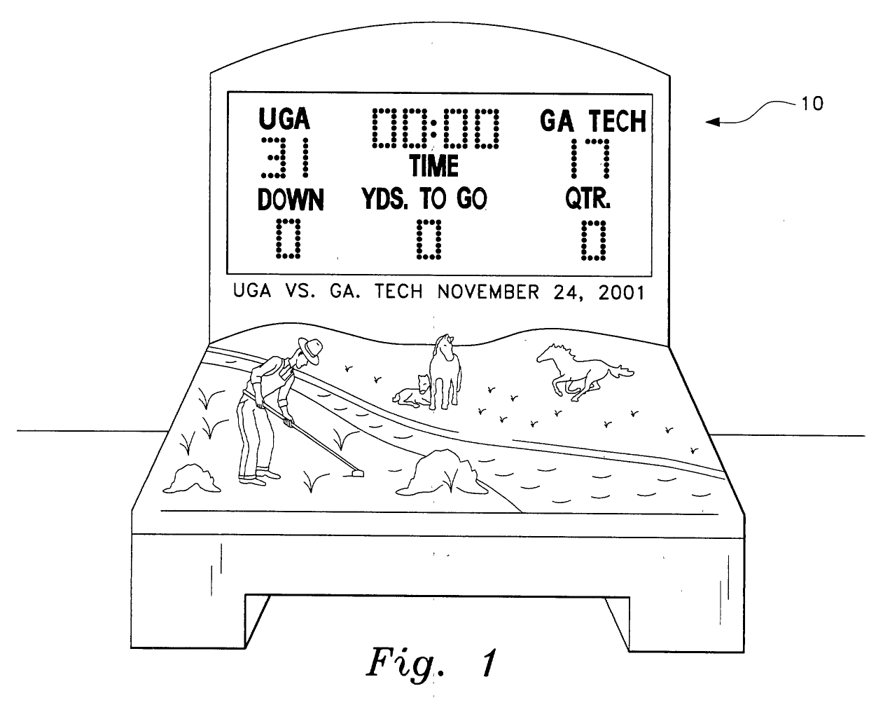

FIGS. 1-3 illustrate examples of miniaturized scoreboard consumer products. FIG. 1 illustrates a decorative item 10, such as desktop ornament or paperweight or the like. The decorative item 10 includes on a surface thereof a miniaturized scoreboard with a predetermined score at a, predetermined time of a predetermined sporting event. The miniaturized scoreboard includes a predetermined score of ‘31’ for the University of Georgia (UGA) and ‘17’ for the University of Georgia Tech (GA TECH). The predetermined time is ‘00:00’. The down is ‘0’, the yards to go is ‘0’, and the quarter is ‘0’. The name and date of the sporting event is ‘UGA VS. GA. TECH Nov. 24, 2001’.

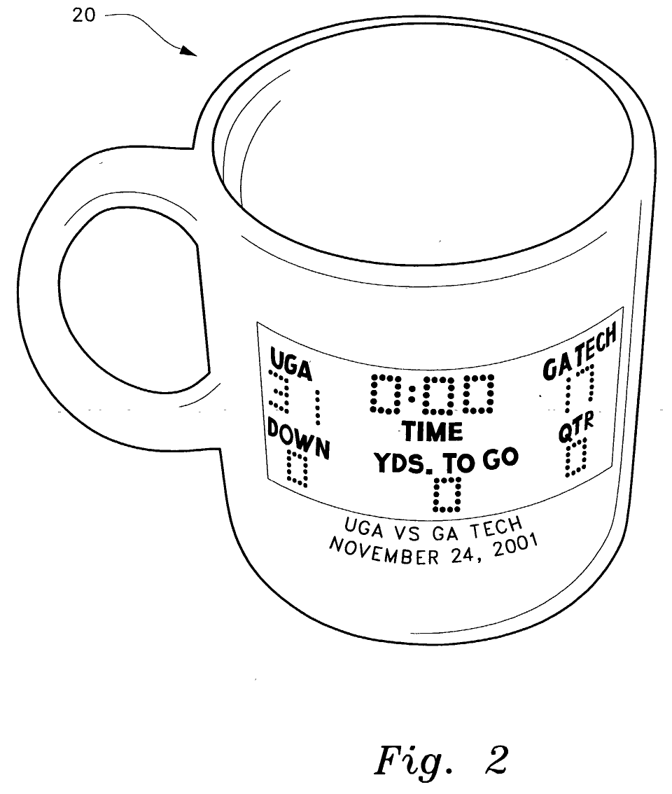

FIG. 2 illustrates a decorative item 20, such as cup or mug or the like. The decorative item 20 includes on a surface thereof a miniaturized scoreboard with a predetermined score at a predetermined time of a predetermined sporting event. The miniaturized scoreboard includes a predetermined score of ‘31’ for the University of Georgia (UGA) and ‘17’ for the University of Georgia Tech (GA TECH). The predetermined time is ‘00:00’. The down is ‘0’, the yards to go is ‘0’, and the quarter is ‘0’. The name and date of the sporting event is ‘UGA VS. GA. TECH NOV. 24, 2001’.

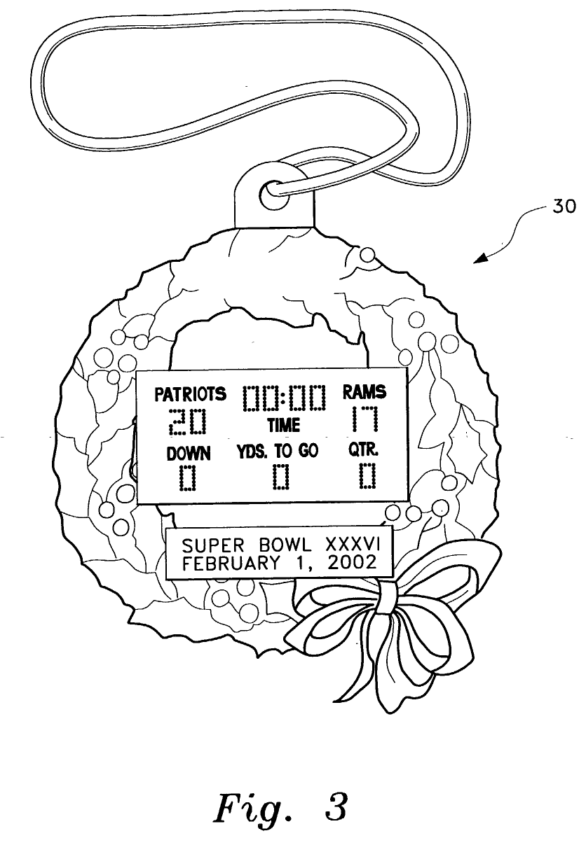

FIG. 3 illustrates a decorative item 30, such as a pendant or the like. The decorative item 30 includes on a surface thereof a miniaturized scoreboard with a predetermined score at a predetermined time of a predetermined sporting event. The miniaturized scoreboard includes a predetermined score of ‘20’ for the New England Patriots (PATRIOTS) and ‘17’ for the Los Angeles Rams (RAMS). The predetermined time is ‘00:00’. The down is ‘0’, the yards to go is ‘0’, and the quarter is ‘0’. The name and date of the sporting event is ‘SUPER BOWL XXXVI Feb. 1, 2002’.

The predetermined sporting events illustrated in FIGS. 1-3 are football events. However, the predetermined sporting events may be any desired sporting event, such as baseball events, racing events, basketball events, hockey events, or the like. In addition the items may any desirable item, such as a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, a bottle, or the like.

A method for producing a miniaturized scoreboard consumer product as described above includes the steps of supplying an item for use as a consumer product, and providing a miniaturized scoreboard with a predetermined score at a predetermined time of a predetermined sporting event, and applying the miniaturized scoreboard on a surface of the item. The method of producing a miniaturized scoreboard consumer product may further include providing a predetermined name a first participant in the predetermined sporting event, a predetermined name of a second participant in the predetermined sporting event, and any more predetermined names of additional participants, according to the desires of the user. The method of producing a miniaturized scoreboard consumer product may further include providing a predetermined name to the predetermined sporting event, and/or a predetermined date to said predetermined sporting event. The method of producing a miniaturized scoreboard consumer product may further include selecting the item as a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, a bottle, or the like.

The miniaturized scoreboard consumer product includes an item for use as a consumer product, and a miniaturized scoreboard with a predetermined score at a predetermined time of a predetermined sporting event, wherein the miniaturized scoreboard is on a surface of the item. The miniaturized scoreboard consumer product may include a predetermined name of a first participant in the predetermined sporting event, a predetermined name of a second participant in the predetermined sporting event, or any number of additional predetermined names of additional participants in the predetermined sporting event. The miniaturized scoreboard consumer product may include a predetermined name of the predetermined sporting event and/or a predetermined date of said predetermined sporting event. The miniaturized scoreboard consumer product may be an item such as a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, a bottle, or the like.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A method of producing a miniaturized scoreboard consumer product comprising:
supplying an item for use as a consumer product; and
providing a miniaturized scoreboard with a predetermined score at a predetermined time of a predetermined sporting event; and
applying said miniaturized scoreboard on a surface of said item.

2. The method of producing a miniaturized scoreboard consumer product according to claim 1, wherein said providing step further includes providing a predetermined name a first participant in said predetermined sporting event.

3. The method of producing a miniaturized scoreboard consumer product according to claim 2, wherein said providing step further includes providing a predetermined name a second participant in said predetermined sporting event.

4. The method of producing a miniaturized scoreboard consumer product according to claim 2, wherein said providing step further includes providing a predetermined name to said predetermined sporting event.

5. The method of producing a miniaturized scoreboard consumer product according to claim 2, wherein said providing step further includes providing a predetermined date to said predetermined sporting event.

6. The method of producing a miniaturized scoreboard consumer product according to claim 2, wherein said providing step further comprises designating said predetermined sporting event as a football event.

7. The method of producing a miniaturized scoreboard consumer product according to claim 2, wherein said providing step further comprises designating said predetermined sporting event as a baseball event.

8. The method of producing a miniaturized scoreboard consumer product according to claim 2, wherein said providing step further comprises designating said predetermined sporting event as a racing event.

9. The method of producing a miniaturized scoreboard consumer product according to claim 2, wherein said supplying step further comprises selecting said item from the group consisting of a device, an implement, a piece of clothing,, a photograph, a plaque, a card, a pennant, a mug, a glass, a stein, a chalice, a baseball, a football, a hockey puck, an ornament, a mouse pad, a plate, a tray, a calendar, a key ring, a can, and a bottle.

10. A miniaturized scoreboard consumer product comprising:
an item for use as a consumer product;
a miniaturized scoreboard with a predetermined score at a predetermined time of a predetermined sporting event,
wherein said miniaturized scoreboard is on a surface of said item.

11. The miniaturized scoreboard consumer product according to claim 10, wherein said predetermined name includes a first participant in said predetermined sporting event.

12. The method of producing a miniaturized scoreboard consumer product according to claim 11, wherein said predetermined name includes a second participant in said predetermined sporting event.

13. The miniaturized scoreboard consumer product according to claim 10, wherein said miniaturized scoreboard further comprises a predetermined name of said predetermined sporting event.

14. The miniaturized scoreboard consumer product according to claim 10, wherein said miniaturized scoreboard further comprises a predetermined date of said predetermined sporting event.

15. The miniaturized scoreboard consumer product according to claim 10, wherein said predetermined sporting event is a football event.

16. The miniaturized scoreboard consumer product according to claim 10, wherein said predetermined sporting event is a baseball event.

17. The miniaturized scoreboard consumer product according to claim 10, wherein said predetermined sporting event is a racing event.

18. The miniaturized scoreboard consumer product according to claim 10, wherein said item is selected from the group consisting of a device, an implement, a piece of clothing, a photograph, a plaque, a card, a pennant, a mug, a glass, a stein, a chalice, a baseball, a football, a hockey puck, an ornament, a mouse pad, a plate, a tray, a calendar, a key ring, a can, and a bottle.
